(19) United States
(12) Patent Application Publication
(10) Pub. No.: US 2026/0265866 A1
(43) Pub. Date: Sep. 10, 2026

(54) INORGANIC SUBSTANCE SOLUTION PRODUCTION METHOD, AND INORGANIC SUBSTANCE SOLUTION PRODUCTION APPARATUS

(71) Applicant: National Institutes for Quantum Science and Technology, Chiba (JP)

(72) Inventors: Masaru NAKAMICHI, Chiba (JP); Suguru NAKANO, Chiba (JP); Yoshiaki AKATSU, Chiba (JP); Shota YOKOHAMA, Chiba (JP); Jaehwan KIM, Chiba (JP); Taehyun HWANG, Chiba (JP); Yutaka SUGIMOTO, Chiba (JP)

(21) Appl. No.: 19/164,805

(22) PCT Filed: Mar. 12, 2024
(86) PCT No.: PCT/JP2024/009499

§ 371 Date: Sep. 12, 2025

(30) Foreign Application Priority Data
Mar. 14, 2023 (JP) 2023-040081

(51) Int. Cl. C22B 26/12; C22B 1/02; C22B 3/06; C22B 3/12; C22B 4/02

(52) U.S. Cl. CPC C22B 26/12; C22B 1/02; C22B 3/06; C22B 3/12; C22B 4/02

(57) ABSTRACT

An inorganic substance solution production method for dissolving an inorganic substance such as lithium ore is provided, which includes: a mixing step of mixing an inorganic substance that is phase-changed or thermally decomposed by heating and an additive to obtain a first mixture; and a heating step of heating the first mixture at a heating temperature not lower than a predetermined temperature to obtain a second mixture of the inorganic substance and the additive, a proportion of the additive to the inorganic substance in the mixing step being 0.5 or more in terms of molar ratio, and the predetermined temperature being (1) a temperature at which phase change occurs when the inorganic substance is an inorganic substance whose phase is to be changed by heating and (2) a temperature at which thermal decomposition occurs when the inorganic substance is an inorganic substance which is to be thermally decomposed by heating.

### TECHNICAL FIELD

The present invention relates to a method for producing an inorganic substance solution and a device for producing an inorganic substance solution.

### BACKGROUND ART

As lithium ore, spodumene (LiAlSi₂O₆), lepidolite (K(Al,Li)₂(Si,Al)₄O₁₀(OH,F)₂), petalite (LiAlSi₄O₁₀), elbaite (Na(Li,Al)₃Al₆(BO₃)₃Si₆O₁₈(OH)₄), and hectorite (Na_{0.3}(Mg,Li)₃Si₄O₁₀(OH)₂) are known.

In a case where lithium is recovered from lithium ore, lithium is extracted from the lithium ore by dissolving the lithium ore in a solvent. However, it is not easy to dissolve the lithium ore in the solvent.

Therefore, in Non-Patent Literature 1, a method is used in which lithium ore is calcined at 1000° C. or more and then roasted at 250° C. with concentrated sulfuric acid.

In Patent Literature 1, a method is used in which lithium ore and a trace amount of calcium oxide are mixed and heated at 1000° C. to 1300° C. and then dissolved in an acid solution at 400° C. under pressure. The amount of the calcium oxide mixed with the lithium ore in this technique is 0.08 or more and less than 0.34 in terms of molar ratio relative to the amount of the lithium ore. The pressure in the dissolving process is 90 atm or more.

### CITATION LIST

### Patent Literature

### [Patent Literature 1]

U.S. Pat. No. 2,662,809, specification

### Non-Patent Literature

### [Non-Patent Literature 1]

Songyan Jiang et. al., Environmental impacts of lithium production showing the importance of primary data of upstream process in life-cycle assessment, Journal of Environmental Management, Volume 262, 110253, 2020

### SUMMARY OF INVENTION

### Technical Problem

However, in the conventional techniques disclosed in Non-Patent Literature 1 and Patent Literature 1, it is necessary to heat the lithium ore to 250° C. or 400° C. in the dissolving process to dissolve the lithium ore in the acid solution. In the conventional technique disclosed in Patent Literature 1, in the dissolving process, it is necessary to carry out pressurization at high pressure of not less than 90 atm in addition to heating.

The invention in accordance with an aspect of the present invention is accomplished in view of the problems described above, and an object thereof is to provide a technique that makes it possible to dissolve an inorganic substance such as lithium ore more easily than the conventional techniques disclosed in Non-Patent Literature 1 and Patent Literature 1.

### Solution to Problem

In order to attain the object, a method for producing an inorganic substance solution in accordance with an aspect of the present invention includes: a mixing step of mixing an inorganic substance and an additive to obtain a first mixture, the inorganic substance being phase-changed or thermally decomposed by heating, and the additive being at least one of a hydroxide of alkali metal, a hydroxide of alkaline earth metal, and an oxide of alkaline earth metal; and a heating step of heating the first mixture at a heating temperature not lower than a predetermined temperature to obtain a second mixture of the inorganic substance and the additive. In this production method, a configuration is employed in which a proportion of the additive to the inorganic substance in the mixing step is 0.5 or more in terms of molar ratio, and the predetermined temperature is (1) a temperature at which phase change occurs in a case where the inorganic substance is an inorganic substance whose phase is to be changed by heating and (2) a temperature at which thermal decomposition occurs in a case where the inorganic substance is an inorganic substance which is to be thermally decomposed by heating.

In order to attain the object, a method for producing an inorganic substance solution in accordance with an aspect of the present invention includes: a phase changing step of changing, by heating, a phase of an inorganic substance that is to be phase-changed by heating; a mixing step of mixing the inorganic substance which has been phase-changed and an additive to obtain a first mixture, the additive being at least one of a hydroxide of alkali metal, a hydroxide of alkaline earth metal, and an oxide of alkaline earth metal; and a heating step of heating the first mixture to obtain a second mixture of the inorganic substance and the additive. In this inorganic substance solution production method, a configuration is employed in which a proportion of the additive to the inorganic substance in the mixing step is 0.5 or more in terms of molar ratio.

In order to attain the object, a method for producing an inorganic substance solution in accordance with an aspect of the present invention includes: a mixing step of mixing an inorganic substance and an additive to obtain a first mixture, the inorganic substance containing β-spodumene, and the additive being at least one of a hydroxide of alkali metal, a hydroxide of alkaline earth metal, and an oxide of alkaline earth metal; and a heating step of heating the first mixture to obtain a second mixture of the inorganic substance and the additive. In this production method, a configuration is employed in which a proportion of the additive to the inorganic substance in the mixing step is 0.5 or more in terms of molar ratio.

In order to attain the object, a device for producing an inorganic substance solution in accordance with an aspect of the present invention includes: a mixing section for mixing an inorganic substance and an additive to obtain a first mixture, the inorganic substance being phase-changed or thermally decomposed by heating, and the additive being at least one of a hydroxide of alkali metal, a hydroxide of alkaline earth metal, and an oxide of alkaline earth metal; and a heating section for heating the first mixture at a heating temperature not lower than a predetermined temperature to obtain a second mixture of the inorganic substance and the additive. In this production device, a configuration is employed in which a proportion of the additive to the inorganic substance in the mixing section is 0.5 or more in terms of molar ratio, and the predetermined temperature is (1) a temperature at which phase change occurs in a case where the inorganic substance is an inorganic substance whose phase is to be changed by heating and (2) a temperature at which thermal decomposition occurs in a case where the inorganic substance is an inorganic substance which is to be thermally decomposed by heating.

### Advantageous Effects of Invention

According to an aspect of the present invention, it is possible to provide a technique that makes it possible to dissolve an inorganic substance such as lithium ore more easily than the conventional techniques disclosed in Non-Patent Literature 1 and Patent Literature 1.

### BRIEF DESCRIPTION OF DRAWINGS

FIG. 1 is a flowchart illustrating a method in accordance with Embodiment 1 of the present invention for producing an inorganic substance solution.

FIG. 2 is a flowchart illustrating a method in accordance with Embodiment 2 of the present invention for producing an inorganic substance solution.

FIG. 3 is a flowchart illustrating a method in accordance with Embodiment 3 of the present invention for producing an inorganic substance solution.

FIG. 4 is a flowchart illustrating a method in accordance with Embodiment 4 of the present invention for producing an inorganic substance solution.

FIG. 5 is a flowchart illustrating a method in accordance with Embodiment 5 of the present invention for producing an inorganic substance solution.

FIG. 6 is a view schematically illustrating a dielectric heating device in accordance with Embodiment 6 of the present invention.

FIG. 7 is a perspective view of an isolator included in the dielectric heating device shown in FIG. 6.

FIG. 8 is a view schematically illustrating an inorganic substance solution production device included in an inorganic substance solution production system in accordance with Embodiment 7 of the present invention.

FIG. 9 is a photograph showing a heated mixture obtained in Example 1.

FIG. 10 is a graph showing a result of an X-ray diffraction (XRD) test on an inorganic substance contained in the heated mixture obtained in Example 1.

FIG. 11 is a graph showing a result of an XRD test on an inorganic substance contained in a solid phase of an inorganic substance solution obtained in Example 1.

FIG. 12 is a graph showing a result of an XRD test on an inorganic substance contained in a mixture obtained after heating in Example 2.

FIG. 13 is a graph showing a relationship between an elution rate of lithium in an inorganic substance solution obtained in Example 3 and a weight ratio of natural spodumene and calcium carbonate.

### DESCRIPTION OF EMBODIMENTS

### Embodiment 1

### (Method for Producing Inorganic Substance Solution)

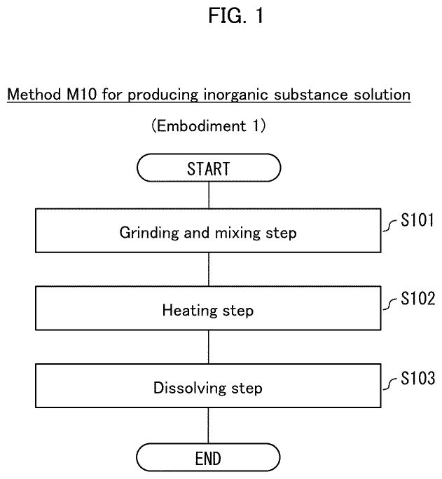

The following description will discuss a method M10 for producing an inorganic substance solution in accordance with Embodiment 1 of the present invention, with reference to FIG. 1. FIG. 1 shows a flowchart of the method M10 for producing an inorganic substance solution. Hereinafter, the method M10 for producing an inorganic substance solution may also simply be referred to as a production method M10. Hereinafter, the inorganic substance solution means a solution in which an inorganic substance which is a starting material is dissolved. The inorganic substance is a generic term for inorganic compounds and metals. The inorganic compound refers to a compound other than an organic substance or an organic compound, that is, a compound that does not contain carbon. The inorganic compound preferably contains any of lithium ore (described later) and metals such as rare metals and rare earths. The metals include noble metals. The noble metals encompass gold (Au), silver (Ag), and platinum metals (ruthenium (Ru), rhodium (Rh), palladium (Pd), osmium (Os), iridium (Ir), and platinum (Pt)).

In the present embodiment, lithium ore containing natural spodumene is employed as an inorganic substance used in the production method M10. Spodumene is an example of lithium ore existing in nature. Natural spodumene is classified into an a phase and a β phase according to the crystal structure. Hereinafter, spodumene in the α phase and spodumene in the β phase are referred to as α-spodumene and β-spodumene, respectively. Natural spodumene obtained in mines is mostly α-spodumene. In addition, by heating at a temperature of 1000° C. or higher, spodumene is phase-changed to β-spodumene.

The inorganic substance used in the production method M10 is not limited to ore containing natural spodumene, and it is possible to select the inorganic substance, as appropriate, from inorganic substances whose crystal structure is phase-changed or thermally decomposed by heating. Examples of an inorganic substance which is thermally decomposed by heating include petalite (LiAlSi₄O₁₀).

As shown in FIG. 1, the production method M10 includes a grinding and mixing step S101, a heating step S102, and a dissolving step S103.

### (Grinding and Mixing Step)

In the grinding and mixing step S101, which is an example of the mixing step, an inorganic substance is ground to obtain powder of the inorganic substance. By grinding the inorganic substance, the inorganic substance is mechanically broken to have a smaller particle diameter, and thus efficiency of a chemical reaction with hydroxide or oxide is improved. The technique used to grind the inorganic substance is not limited to any particular one, and may be selected from existing techniques as appropriate. Such a technique may be a technique involving use of a jaw crusher or a ball mill, for example.

In the grinding and mixing step S101, sodium hydroxide (NaOH), which is an example of an additive, is ground to obtain powder of the sodium hydroxide. Note, however, that, in a case where powdery sodium hydroxide is purchased and used, the step of grinding sodium hydroxide in the grinding and mixing step S101 may be omitted. In a case where the sodium hydroxide used in the grinding and mixing step S101 is in the form of granules or flakes, it is possible to omit the grinding of the sodium hydroxide in the grinding and mixing step S101. The form of the sodium hydroxide used in the grinding and mixing step S101 is not limited. The sodium hydroxide is an example of hydroxides. The at least one of hydroxide and oxide used in the production method M10 is not limited to sodium hydroxide, and may be calcium hydroxide (Ca(OH)₂) or calcium oxide (CaO). From sodium hydroxide, calcium hydroxide, and calcium oxide, two or more of these may be selected and combined.

In the grinding and mixing step S101, the ground inorganic substance and the ground additive are mixed together to obtain a mixture of the inorganic substance and the additive. The mixture obtained in the grinding and mixing step S101 is an example of the first mixture. In the present embodiment, the mixture is in the form of powder. Here, a proportion of the additive to the inorganic substance is 0.5 or more in terms of molar ratio. Hereinafter, a proportion of the additive to the inorganic substance is expressed using the molar ratio, unless otherwise specified. As described later, s-spodumene which is employed as the inorganic substance and sodium hydroxide which is employed as the additive react at a ratio of 1:1, and generate lithium metasilicate (Li₂SiO₃) that is easily dissolved in acids or water. In a case where the proportion of the additive to the inorganic substance is excessively higher than 1, the amount of an additive (i.e., a wasted additive) that is not used in a reaction to convert β-spodumene to lithium metasilicate increases. Therefore, the proportion is preferably 0.8 or more and 4 or less, more preferably 1 or more and 2 or less.

### (Heating Step)

In the heating step S102, the mixture obtained in the grinding and mixing step S101 is heated at a heating temperature of not lower than a predetermined temperature, and thus a mixture of the phase-changed or thermally decomposed inorganic substance and the additive is obtained. The predetermined temperature in the heating step S102 is (1) a temperature at which phase change occurs in a case where the inorganic substance is an inorganic substance whose phase is to be changed by heating and (2) a temperature at which thermal decomposition occurs in a case where the inorganic substance is an inorganic substance which is to be thermally decomposed by heating.

The mixture obtained in the heating step S102 is an example of the second mixture. In the heating step S102, the mixture (first mixture) is heated at a temperature at which phase change or thermal decomposition of the crystal structure occurs in the inorganic substance. In the present embodiment, dielectric heating is used as the heating method in the heating step S102, and 700° C. is used as the heating temperature. The heating temperature is a temperature not lower than the temperature (i.e., the predetermined temperature) at which α-spodumene is phase-changed. In the present embodiment, a radiation thermometer is used to measure the temperature of the mixture during dielectric heating. The heating temperature here is the temperature on the surface of the mixture measured using the radiation thermometer. Therefore, it is possible that the inside of the mixture during heating has reached a temperature higher than 700° C.

The heating temperature is not limited to 700° C., and can be set as appropriate within a range of a temperature at which phase change or thermal decomposition occurs in the inorganic substance. The heating time can be set as appropriate within a range where a reaction described later sufficiently proceeds. It is highly possible that, by increasing the heating temperature, the heating time can be shortened.

By carrying out the heating step S102, the sodium hydroxide and the inorganic substance convert energy of electromagnetic waves (described later) into heat energy, and are heated. Consequently, natural spodumene (i.e., α-spodumene) contained in the inorganic substance is phase-changed to β-spodumene. In addition, as indicated below, β-spodumene reacts with sodium hydroxide at a ratio of 1:1 to generate nepheline (NaAlSiO₄), Li₂SiO₃, and quartz (SiO₂).

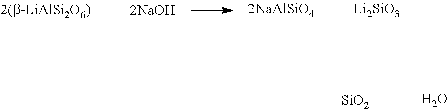

The starting material and the sodium hydroxide do not contain moisture. Therefore, even in a case where the temperature of the mixture during heating exceeds 100° C., it is not necessary to consider boiling of the moisture. Thus, in the heating step S102, it is possible to dielectrically heat the mixture under normal pressure. At least one of the starting material and the additive may contain moisture. In a case where at least one of the starting material and the additive contains moisture, drying (boiling evaporation of moisture) begins when the heating temperature has reached 100° C., and heating further proceeds after the moisture is completely removed. As such, it is possible to carry out heating under normal pressure even in a case where moisture is contained.

The dielectric heating is a generic term for techniques for applying, to a target object, an electromagnetic wave having a given frequency so as to heat the target object. According to the band of the electromagnetic wave to be applied, the dielectric heating is called radio-frequency heating or microwave heating. For example, the radio-frequency heating applies, to the target object, an electromagnetic wave (a so-called short wave or an ultrashort wave) within a band of not less than 3 MHz and less than 300 MHz, whereas the microwave heating applies, to the target object, an electromagnetic wave (a so-called microwave) within a band of not less than 300 MHz and less than 30 GHz. A microwave oven, which is widely used also in home, is an example of a device that can carry out the microwave heating.

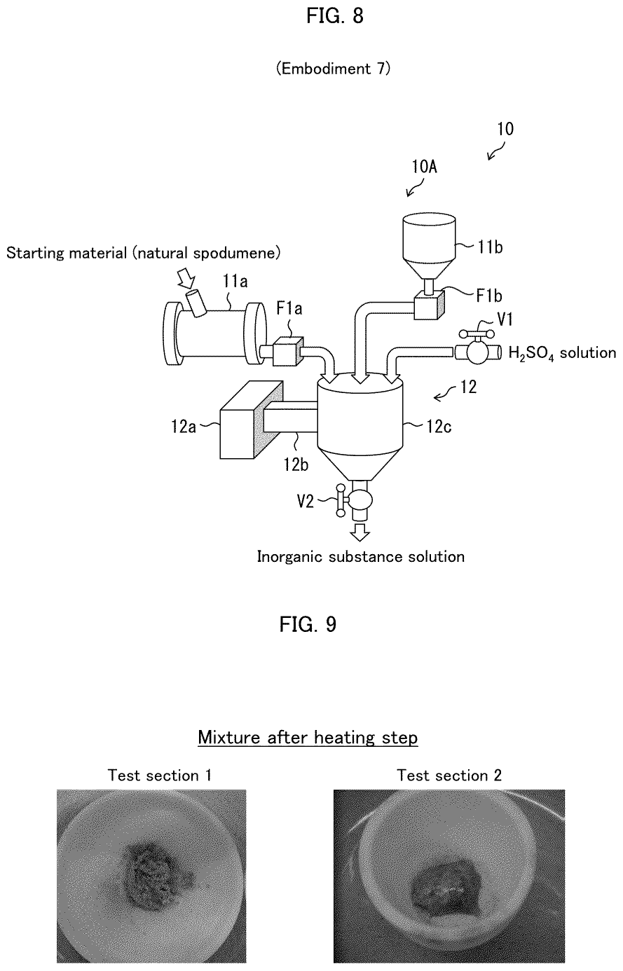

In the present embodiment, the heating step S102 applies, to the mixture, an electromagnetic wave having a frequency of 2.45 GHz. The configuration of the device that applies an electromagnetic wave to the mixture in the form of powder will be described later with reference to FIG. 6 or FIG. 8.

It seems that, by heating the mixture using dielectric heating, it is possible to phase-change the inorganic substance with higher energy efficiency, as compared with a case where external heating is used to heat the mixture. As described later, the mixture which has been heated is easily dissolved in an acid (sulfuric acid in the present embodiment) solution. Therefore, it is possible to obtain a sulfuric acidic solution in which the inorganic substance is dissolved. Therefore, the production method M10 can provide an inorganic substance solution production method in which dissolution in the acid solution can be carried out more easily than conventional production methods. Note, however, that the heating technique used in the heating step S102 may be external heating, instead of dielectric heating. The concentration of the acid solution is not particularly limited, and only needs to be a concentration at which the inorganic substance is dissolved.

### (Dissolving Step)

The dissolving step S103 is a step of dissolving the mixture obtained in the heating step S102 in an acid solution or water to obtain a solution of the inorganic substance contained in the starting material. In the present embodiment, sulfuric acid (H₂SO₄) is used as the solution, and a sulfuric acidic solution of the inorganic substance is obtained. In the present embodiment, a sulfuric acidic solution is obtained in which Li₂SO₄, Al₂(SO₄)₃, H₂SiO₃, and Na₂SO₄ are dissolved.

The acid solution used in the dissolving step S103 is not limited to the sulfuric acidic solution. The acid solution may be at least one of a hydrochloric acidic solution, a nitric acidic solution, a hydrofluoric acidic solution, a hydrobromic acidic solution, a hydroiodic acidic solution. Alternatively, the acid solution may be a mixed acid solution that is obtained by mixing two or more acid solutions of these acid solutions. Examples of the mixed acid solution encompass an aqua regia solution, which is obtained by mixing concentrated hydrochloric acid and concentrated nitric acid. In the dissolving step S103, it is possible to use water as a liquid for dissolving the heated mixture obtained in the heating step S102.

The mixture obtained in the heating step S102 is dissolved in the sulfuric acidic solution at normal temperature and under normal pressure. The sulfuric acidic solution may be heated or pressurized to facilitate the dissolution of the mixture. A suitable way to heat the sulfuric acidic solution is a device that applies an electromagnetic wave used in the heating step S102. In the dissolving step S103, it is preferable to set the temperature of the sulfuric acidic solution to be lower than 250° C. (corresponding to the boiling point of concentrated sulfuric acid) in order to inhibit the boiling of the sulfuric acidic solution. With this feature, pressurization of the sulfuric acidic solution is not necessary, and it is possible to carry out the dissolving step S103 under normal pressure.

### (Variation 1 of Method M10 for Producing Inorganic Substance Solution)

As described above, in the present embodiment, the production method M10 has been described using sodium hydroxide as at least one of hydroxide and oxide. In this variation, the production method M10 will be briefly described for a case where calcium oxide is used instead of sodium hydroxide as an additive.

In the grinding and mixing step S101, natural spodumene is ground to obtain powder of the inorganic substance. Moreover, by grinding the calcium oxide, powder of the calcium oxide is obtained. In the grinding and mixing step S101, the ground inorganic substance and the ground additive are mixed together to obtain a mixture (first mixture) of the inorganic substance and the additive. Here, a proportion of the additive to the inorganic substance is 0.5 or more in terms of molar ratio. In this variation also, the form of the calcium oxide is not limited to powder.

As described below, β-spodumene which is employed as the inorganic substance and calcium oxide which is employed as the additive react at a ratio of 1:1, and generate β-eucryptite (LiAlSiO₄) that is easily dissolved in acids or water. In a case where the proportion of the additive to the inorganic substance is excessively higher than 1, the amount of an additive (i.e., a wasted additive) that is not used in a reaction to convert β-spodumene to β-eucryptite increases. Therefore, the proportion is preferably 0.8 or more and 4 or less, more preferably 1 or more and 2 or less.

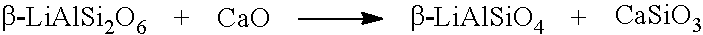

In the heating step S102, the mixture is heated at a temperature at which phase change of the crystal structure occurs in the inorganic substance. In the present embodiment, external heating is used as the heating method in the heating step S102, and 1050° C. is used as the heating temperature. In the present embodiment, the heating temperature during external heating is measured using a thermometer provided to an oven used for external heating. Therefore, the temperature of the mixture is considered to be substantially uniform among the surface and inside thereof.

In the heating step S102, by externally heating the mixture of the powder of the starting material and the powder of calcium oxide at 1050° C., natural spodumene (α-spodumene) is phase-changed to β-spodumene. Furthermore, β-eucryptite and CaSiO₃ are generated from β-spodumene. In the heating step S102, dielectric heating may be used instead of external heating.

The dissolving step S103 in this variation is similar to the dissolving step S103 in the case where sodium hydroxide is used as an additive. Therefore, a description thereof is omitted in this variation. In this variation, a sulfuric acidic solution is obtained in which Li₂SO₄, CaSO₄, H₂SiO₃, and Al₂(SO₄)₃ are dissolved.

As described above, in this variation, calcium oxide can be used as an additive to easily produce an inorganic substance solution.

### (Variation 2 of Method M10 for Producing Inorganic Substance Solution)

As described above, in the present embodiment, natural spodumene (i.e., α-spodumene) is used as an inorganic substance. However, it may be possible that β-spodumene is obtained instead of α-spodumene for some reason. In such a case also, an aspect of the present invention can be suitably utilized.

That is, an aspect of the present invention may include: a mixing step of mixing an inorganic substance containing β-spodumene and the foregoing additive to obtain a mixture (first mixture); and a heating step of heating the mixture to obtain a mixture (second mixture) of the inorganic substance and the additive. In this variation also, a proportion of the additive to the inorganic substance in the mixing step is 0.5 or more in terms of molar ratio.

### Embodiment 2

### (Method M20 for Producing Inorganic Substance Solution)

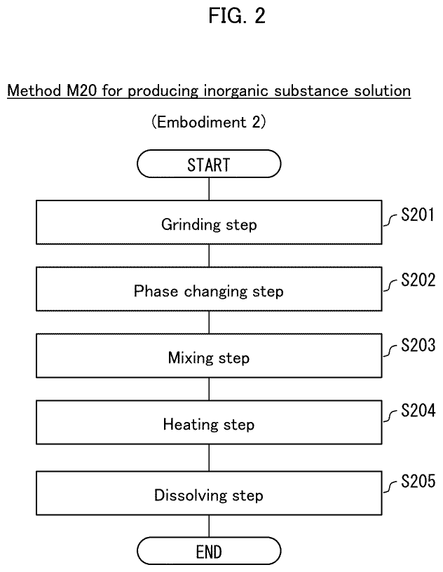

The following description will discuss a method M20 for producing an inorganic substance solution in accordance with Embodiment 2 of the present invention, with reference to FIG. 2. FIG. 2 shows a flowchart of the method M20 for producing an inorganic substance solution. Hereinafter, the method M20 for producing an inorganic substance solution may also simply be referred to as a production method M20.

As shown in FIG. 2, the production method M20 includes a grinding step S201, α phase changing step S202, a mixing step S203, a heating step S204, and a dissolving step S205.

### (Grinding Step)

In the grinding step S201, an inorganic substance is ground to obtain powder of the inorganic substance. In the present embodiment, natural spodumene is employed as an inorganic substance used in the production method M20. In the grinding step S201, sodium hydroxide (NaOH) is ground to obtain powder of the sodium hydroxide. The grinding method can be carried out with the method described for the grinding and mixing step S101 of the production method M10.

### (Phase Changing Step)

In the phase changing step S202, the powder of the inorganic substance obtained in the grinding step S201 is phase-changed by heating. In the present embodiment, natural spodumene (α-spodumene) contained in the inorganic substance is phase-changed to β-spodumene by dielectric heating. The heating method used in the phase changing step S202 can be the method described for the heating step S102 of the production method M10. The heating method used in the phase changing step S202 is not limited to dielectric heating, and may alternatively be external heating.

### (Mixing Step)

The mixing step S203 is a step that is to be carried out after the phase changing step S202. The β-spodumene obtained in the phase changing step S202 and the powder of sodium hydroxide obtained in the grinding step S201 are mixed together to obtain a mixture of the inorganic substance and the additive. In the mixing step S203, other than the ground sodium hydroxide, it is possible to use at least one of the additives described in the grinding and mixing step S101 of the production method M10.

### (Heating Step)

In the heating step S204, the mixture obtained in the mixing step S203 is heated to obtain a mixture of the inorganic substance and the additive. In the heating step S204, the mixture is heated at a temperature at which phase change of the crystal structure occurs in the inorganic substance. That is, the heating step S204 is similar to the heating step S102 of the production method M10. Therefore, a description thereof is omitted in the present embodiment.

### (Dissolving Step)

The dissolving step S205 is a step that is to be carried out after the heating step S204. The mixture obtained in the heating step S204 is dissolved in an acid solution or water to obtain a solution of the inorganic substance. The dissolving step S205 is a heating step similar to the dissolving step S103 of the production method M10. Therefore, a description thereof is omitted in the present embodiment.

By carrying out the present embodiment as described above, the heated inorganic substance and at least one of hydroxide and oxide can be mixed together to easily produce an inorganic substance solution.

### Embodiment 3

(Method for Producing Lithium Carbonate (Li₂CO₃))

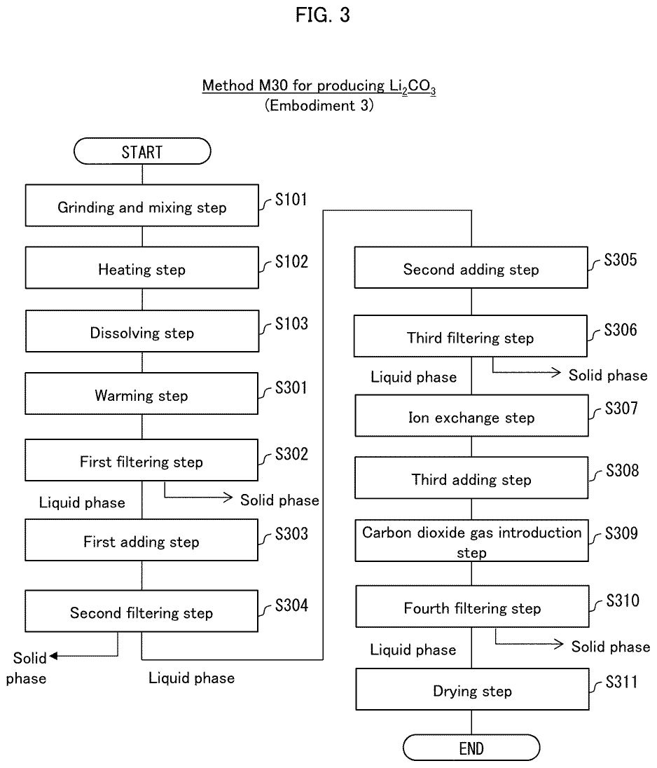

The following description will discuss a method M30 for producing lithium carbonate (Li₂CO₃) in accordance with Embodiment 3 of the present invention, with reference to FIG. 3. FIG. 3 shows a flowchart of the production method M30. Hereinafter, the method M30 for producing lithium carbonate may also simply be referred to as a production method M30. In the present embodiment, natural spodumene is used as the starting material.

As shown in FIG. 3, the production method M30 includes the production method M10 shown in FIG. 1 (i.e., the grinding and mixing step S101, the heating step S102, and the dissolving step S103), a warming step S301, a first filtering step S302, a first adding step S303, a second filtering step S304, a second adding step S305, a third filtering step S306, an ion exchange step S307, a third adding step S308, a carbon dioxide gas introduction step S309, a fourth filtering step S310, and a drying step S311.

The grinding and mixing step S101, the heating step S102, and the dissolving step S103 included in the production method M30 are similar to the respective steps described in Embodiment 1. Therefore, descriptions of the heating step S102 and the dissolving step S103 are omitted here. That is, assuming that an inorganic substance solution has already been obtained, only the warming step S301 and the subsequent steps will be described for the production method M30.

The warming step S301 is a step that is to be carried out after the dissolving step S103. In the warming step S301, the inorganic substance solution obtained in the dissolving step S103 is warmed at 60° C. to leach the inorganic substance.

The first filtering step S302 is a step that is to be carried out after the warming step S301. The first filtering step S302 is a step of separating, with use of a filter, a solid phase and a liquid phase contained in the solution from each other. The solid phase contains an Si compound.

The first adding step S303 is a step that is to be carried out after the first filtering step S302. In the first adding step S303, sodium hydroxide is added to a liquid phase obtained as a result of separation in the first filtering step S302 and thus the polarity of the liquid phase is adjusted from acidity to basicity.

The second filtering step S304 is a step that is to be carried out after the first adding step S303. The second filtering step S304 is a step of separating, with use of a filter, a solid phase and a liquid phase contained in the solution from each other. The solid phase contains an Al compound, an Mg compound, an Fe compound, and an SO₄ compound.

The second adding step S305 is a step that is to be carried out after the second filtering step S304. In the second adding step S305, sodium carbonate is added to the liquid phase obtained as a result of separation in the second filtering step S304, and thus the alkalinity of the liquid phase is attenuated.

The third filtering step S306 is a step that is to be carried out after the second adding step S305. The third filtering step S306 is a step of separating, with use of a filter, a solid phase and a liquid phase contained in the solution from each other. The solid phase contains CaCO₃.

The ion exchange step S307 is a step that is to be carried out after the third filtering step S306. In the ion exchange step S307, ion exchange of the liquid phase obtained as a result of separation in the third filtering step S306 is carried out using an ion exchange resin.

The third adding step S308 is a step that is to be carried out after the ion exchange step S307. In the third adding step S308, at least one of sodium carbonate and sodium hydroxide is added to the liquid phase after ion exchange.

The carbon dioxide gas introduction step S309 is a step that is to be carried out after the third adding step S308. The carbon dioxide gas introduction step S309 is a step that introduces a carbon dioxide gas into the solution so that lithium carbonate is precipitated in the solution.

The fourth filtering step S310 is a step that is to be carried out after the carbon dioxide gas introduction step S309. The fourth filtering step S310 is a step of heating and concentrating the solution, and separating, from the solution, lithium carbonate precipitated in the solution, with use of a filter. The liquid phase contains sodium carbonate (Na₂CO₃) and sodium sulfate (Na₂SO₄).

The drying step S311 is a step that is to be carried out after the fourth filtering step S310. The drying step S311 is a step of drying the lithium carbonate obtained as a result of separation in the fourth filtering step S310.

By carrying out the method M30 for producing lithium carbonate, it is possible to obtain lithium carbonate that is a solid.

### Embodiments 4 and 5

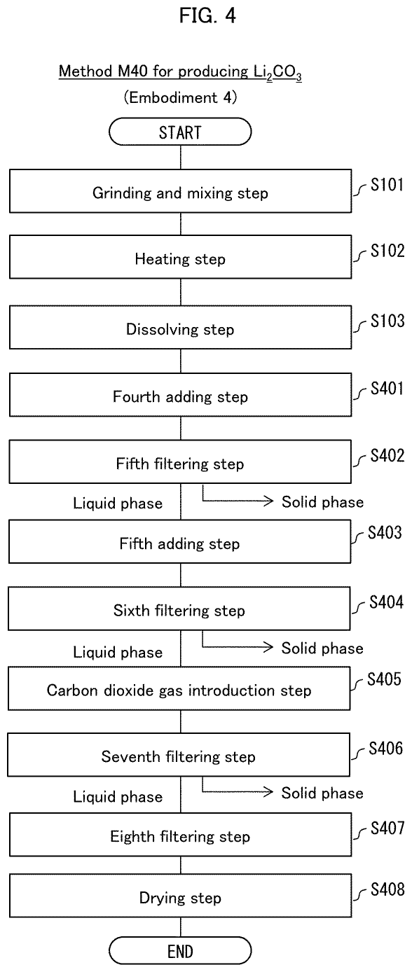

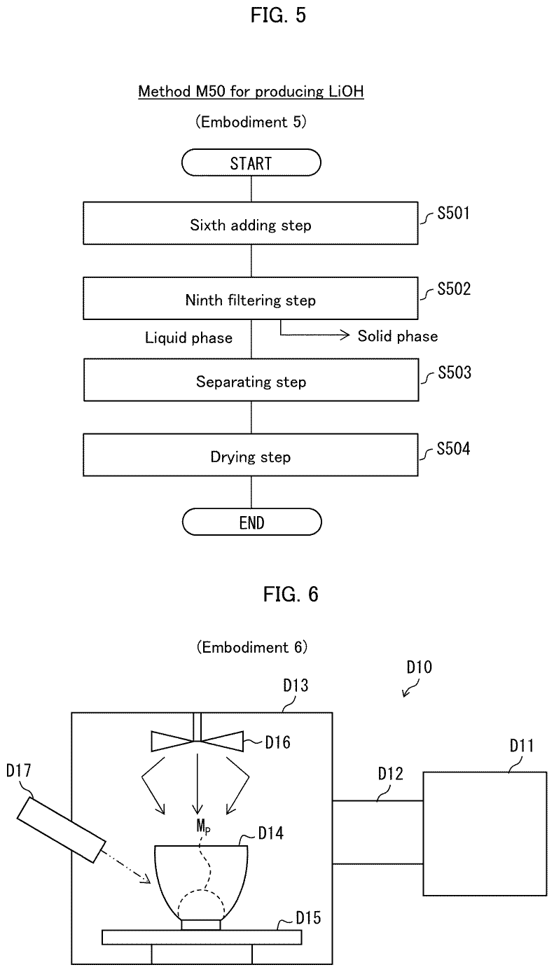

With reference to FIGS. 4 and 5, the following will discuss a method M40 for producing lithium carbonate (Li₂CO₃) in accordance with Embodiment 4 of the present invention and a method M50 for producing lithium hydroxide (LiOH) in accordance with Embodiment 5 of the present invention. FIG. 4 shows a flowchart of the method M40 for producing lithium carbonate and FIG. 5 shows a flowchart of the method M50 for producing lithium hydroxide. Hereinafter, the method M40 for producing lithium carbonate and the method M50 for producing lithium hydroxide may also simply be referred to as a production method M40 and a production method M50, respectively.

### (Method M40 for Producing Lithium Carbonate)

As shown in FIG. 4, the production method M40 includes the grinding and mixing step S101, the heating step S102, and the dissolving step S103 included in the production method M10 shown in FIG. 1, a fourth adding step S401, a fifth filtering step S402, a fifth adding step S403, a sixth filtering step S404, a carbon dioxide gas introduction step S405, a seventh filtering step S406, an eighth filtering step S407, and a drying step S408.

In the present embodiment, natural spodumene is used as the starting material. Moreover, calcium oxide is used as at least one of hydroxide and oxide.

The grinding and mixing step S101, the heating step S102, and the dissolving step S103 included in the production method M40 are similar to the respective steps described in the variation of Embodiment 1. Therefore, descriptions of the heating step S102 and the dissolving step S103 are omitted here. That is, assuming that an inorganic substance solution has already been obtained, only the fourth adding step S401 and the subsequent steps are described for the production method M30.

The fourth adding step S401 is a step that is to be carried out after the dissolving step S103. In the fourth adding step S401, calcium hydroxide (Ca(OH)₂), calcium carbonate (CaCO₃), or sodium hydroxide is added to the inorganic substance solution obtained in the dissolving step S103 and thus the polarity of the solution is adjusted from acidity to basicity.

The fifth filtering step S402 is a step that is to be carried out after the fourth adding step S401. The fifth filtering step S402 is a step of separating, with use of a filter, a solid phase contained in a liquid phase and the liquid phase from each other. The solid phase contains an Si compound and a reaction residue.

The fifth adding step S403 is a step that is to be carried out after the fifth filtering step S402. The fifth adding step S403 is a step of adding, to the liquid phase obtained as a result of separation in the fifth filtering step, at least one of calcium hydroxide and sodium hydroxide.

The sixth filtering step S404 is a step that is to be carried out after the fifth adding step S403. The sixth filtering step S404 is a step of separating, with use of a filter, a solid phase contained in a liquid phase and the liquid phase from each other. The solid phase contains an Mg compound, an Fe compound, and calcium hydroxide.

The carbon dioxide gas introduction step S405 is identical with the carbon dioxide gas introduction step S309 included in the lithium carbonate production method M30 shown in FIG. 4. Thus, a description of the carbon dioxide gas introduction step S405 is omitted in the present embodiment. By carrying out the carbon dioxide gas introduction step S405, calcium carbonate is precipitated in the solution.

The seventh filtering step S406 is a step that is to be carried out after the carbon dioxide gas introduction step S405. The seventh filtering step S406 is a step of separating, with use of a filter, calcium carbonate precipitated in the liquid phase from the solution.

The eighth filtering step S407 is a step that is to be carried out after the seventh filtering step S406. The eighth filtering step S407 is a step of heating and concentrating the liquid phase obtained as a result of separation in the seventh filtering step S406, and separating the liquid phase from the solid phase in the solution using a filter. The solid phase contains lithium carbonate, and the liquid phase contains sodium sulfate and sodium carbonate.

The drying step S408 is a step identical with the drying step S311 included in the lithium carbonate production method M30 shown in FIG. 3. In the drying step S408, the lithium carbonate obtained as a result of separation in the eighth filtering step S407 is dried.

As described above, by carrying out the method M40 for producing lithium carbonate, it is possible to obtain lithium carbonate that is a solid.

### (Method M50 for Producing Lithium Hydroxide)

As shown in FIG. 5, the production method M50 includes a sixth adding step S501, a ninth filtering step S502, a separating step S503, and a drying step S504.

In the present embodiment, the lithium carbonate obtained in the production method M50 is used.

The sixth adding step S501 is a step of adding calcium hydroxide to the lithium carbonate obtained in the production method M50. By the sixth adding step S501, calcium is precipitated by formation of calcium carbonate (CaCO₃), which is carbonate, and lithium is dissolved by ionization with hydroxide ions.

The ninth filtering step S502 is a step that is to be carried out after the sixth adding step S501. The ninth filtering step S502 is a step of separating, with use of a filter, a liquid phase and a solid phase in the solution from each other. The solid phase contains calcium sulfate. The liquid phase contains lithium that has been ionized together with hydroxide ions.

The separating step S503 is a step that is to be carried out after the ninth filtering step S502. The separating step S503 carries out concentration under reduced pressure and centrifugation on the solution containing lithium having been ionized with hydroxide ions. By carrying out the separating step S503, a suspension in which the lithium hydroxide is dispersed is obtained.

The drying step S504 is a step of evaporating the solution obtained as a result of separation in the separating step S503 and drying the lithium hydroxide having been deposited.

As described above, by carrying out the method M50 for producing lithium hydroxide, it is possible to obtain lithium hydroxide that is a solid.

### Embodiment 6

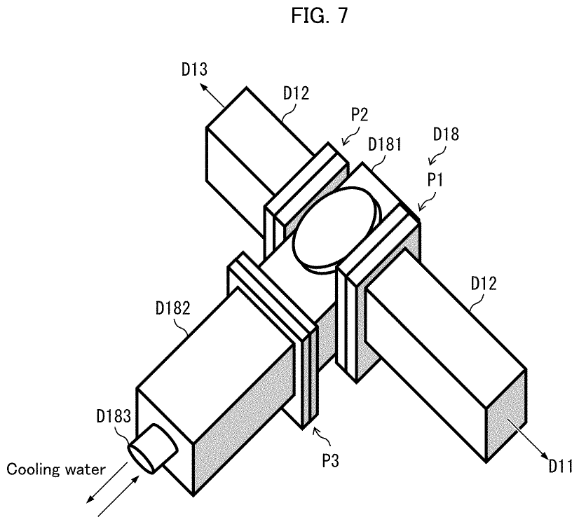

The following description will discuss a dielectric heating device D10 in accordance with Embodiment 6 of the present invention, with reference to FIGS. 6 and 7. The dielectric heating device D10 is an example of the heating section included in the inorganic substance solution production device in accordance with an aspect of the present invention. FIG. 6 is a view schematically illustrating the dielectric heating device D10. The dielectric heating device D10 is a heating device that carries out the heating step S102 included in the production method M10 shown in FIG. 1. In a case where the sulfuric acidic solution is heated in the dissolving step S103 included in the production method M10, it is possible to use the dielectric heating device D10 also for the heating.

As described in Embodiment 1, the dielectric heating is classified into the radio-frequency heating or the microwave heating depending on the band of an electromagnetic wave to be applied. The dielectric heating device D10 is a device that carries out, among the radio-frequency heating and the microwave heating, the microwave heating with respect to a target object.

### <Configuration of Dielectric Heating Device>

As shown in FIG. 6, the dielectric heating device D10 includes an electromagnetic wave generator D11, a waveguide D12, an electromagnetic wave applying section D13, a container D14, a rotary table D15, a stirrer D16, and a thermometer D17. The dielectric heating device D10 further includes an isolator D18 as shown in FIG. 7. The dielectric heating device D10 further includes a control section, which is not shown in FIG. 6.

### (Electromagnetic Wave Generator)

The electromagnetic wave generator D11 is configured to oscillate an electromagnetic wave having a given frequency. The given frequency can be selected as appropriate within, for example, the band of a microwave. In the present embodiment, the given frequency is 2.45 GHz. The frequency of 2.45 GHz is identical to that of an electromagnetic wave used in microwave ovens for home use.

### (Waveguide)

The waveguide D12 is a metal tubular member. The waveguide D12 has a first end connected with the electromagnetic wave generator D11 and a second end connected with the electromagnetic wave applying section D13 accommodating the later-described container D14. That is, the waveguide D12 is provided between the electromagnetic wave generator D11 and the container D14. The waveguide D12 guides, from the first end to the second end, an electromagnetic wave generated by the electromagnetic wave generator D11. Then, the waveguide D12 discharges the electromagnetic wave from the second end to an internal space of the electromagnetic wave applying section D13 accommodating the container D14. That is, the waveguide D12 guides, from the electromagnetic wave generator D11 toward the container D14, an electromagnetic wave generated by the electromagnetic wave generator D11.

### (Isolator)

FIG. 7 is a perspective view of the isolator D18 included in the dielectric heating device D10. As shown in FIG. 7, the isolator D18 is provided midway along of the waveguide D12. The isolator D18 includes a circulator D181, a dummy load D182, and a cooling tube D183. The circulator D181 is inserted midway along the waveguide D12.

The circulator D181 includes a magnet (e.g., made of ferrite), and includes three ports P1 to P3 as shown in FIG. 7. The port P1 is connected to the electromagnetic wave generator D11 via one section of the waveguide D12. The port P2 is connected to the electromagnetic wave applying section D13 via the other section of the waveguide D12. The port P3 is provided with the dummy load D182.

A magnetic field formed by the magnet and an electromagnetic wave passing through the circulator D181 interact with each other. Consequently, the electromagnetic wave which has entered the port P1 is emitted from the port P2, and the electromagnetic wave which has entered the port P2 is emitted from the port P3. With the arrangement, the circulator D181 (i) couples the electromagnetic wave generated by the electromagnetic wave generator D11 to the electromagnetic wave applying section D13 and (ii) couples the electromagnetic wave reflected in the internal space of the electromagnetic wave applying section D13 to the dummy load D182.

The dummy load D182 is made of a material that absorbs an electromagnetic wave having a frequency of 2.45 GHz. Therefore, the dummy load D182 absorbs the electromagnetic wave reflected in the internal space of the electromagnetic wave applying section D13, and converts energy of the electromagnetic wave into heat.

The dummy load D182 is provided with the cooling tube D183. The cooling tube D183 has an internal configuration in which a cooled coolant (e.g., water or air) is circulated. The cooled coolant can remove heat from the dummy load D182. Therefore, it is possible to prevent the temperature of the dummy load D182 from excessively rising.

The circulator D181 configured as described above can (i) couple the electromagnetic wave generated by the electromagnetic wave generator D11 to the electromagnetic wave applying section D13 with little loss, and (ii) absorb the electromagnetic wave reflected in the internal space of the electromagnetic wave applying section D13. That is, the circulator D181 can (i) propagate the electromagnetic wave from the electromagnetic wave generator D11 to the container D14 with little loss, and (ii) absorb the electromagnetic wave propagating from the container D14 to the electromagnetic wave generator D11. This makes it possible to reduce a case where the electromagnetic wave reflected in the internal space of the electromagnetic wave applying section D13 returns to the electromagnetic wave generator D11 and adversely affects the operation of the electromagnetic wave generator D11.

### (Electromagnetic Wave Applying Section)

The electromagnetic wave applying section D13 is a metal box-shaped member being hollow and having an internal space in which the container D14 can be accommodated. The electromagnetic wave applying section D13 applies, to the container D14 and a target object to be heated (i.e., a heating target object) that is accommodated in the container D14, the electromagnetic wave emitted from the second end of the waveguide D12. The electromagnetic wave applying section D13 is configured to confine an electromagnetic wave in the internal space so that the electromagnetic wave hardly leaks to the outside.

### (Container)

In the present embodiment, the container D14 is a container that is shaped to be a bowl. The shape of the container D14 is not limited, provided that the container D14 can accommodate a mixture of a starting material and sodium hydroxide. It is preferable, however, to be a container having a certain depth and having a smaller bottom diameter as compared with the opening diameter for efficiently applying an electromagnetic wave. In a case where a container such as a dish having a shallow depth is used as the container D14, the mixture of the inorganic substance and the additive is widely dispersed and thus may not be heated sufficiently.

For measuring the temperature of the inorganic substance or the mixture using the thermometer D17 (described later), the container D14 preferably has an opening having a large diameter. In a case where the dissolving step S103 is carried out while continuously using the container D14 after the heating step S102, the container D14 preferably has a capacity that can accommodate a given amount of the sulfuric acidic solution.

In a case where a mortar is used to mix the powder of the starting material with sodium hydroxide to obtain a mixture, the mortar functions as the mixing section. In a case where the powder of the starting material and the powder of the sodium hydroxide are placed in the container D14 and are mixed together in the container D14 to obtain a mixture, the container D14 functions as the mixing section.

The container D14 is preferably made of a material having a high transmittance for an electromagnetic wave (in the present embodiment, an electromagnetic wave of 2.45 GHz) to be oscillated by the electromagnetic wave generator D11. The container D14 is preferably made of a material highly resistant to acids and bases. In a case where the container D14 is made of a material highly resistant to acids and bases, after the heating step S102 is carried out, the dissolving step S103 can be carried out by pouring a nitric acidic solution into the container D14.

In the present embodiment, the container D14 is made of a fluorine-based resin, such as polytetrafluoroethylene. The material constituting the container D14 is not limited to the fluorine-based resin, and may be an aromatic polyether ketone resin such as polyether ketone, a polyimide resin, or an oxide such as alumina or titanium oxide.

### (Rotary Table)

The rotary table D15 is a sample table provided on a bottom plane of the internal space of the electromagnetic wave applying section D13, and has an upper surface on which the container D14 can be placed. The rotary table D15 has a circular shape in a plan view, and is configured to be rotatable, at a given speed, about a center axis of the circular shape as a rotation axis. With this configuration, the container D14 placed on the upper surface of the rotary table D15 rotates at a given speed. This can heat the mixture more uniformly.

### (Stirrer)

The stirrer D16 is a metal blade member provided to a ceiling plane of the internal space of the electromagnetic wave applying section D13. The blade member has a center coupled to a supporting rod, with which the blade member is rotatably fixed to the ceiling plane. The stirrer D16 rotates about the supporting rod as a rotation axis at a given speed, thereby reflecting an electromagnetic wave oscillated by the electromagnetic wave generator D11. Consequently, the electromagnetic wave is scattered into the internal space of the electromagnetic wave applying section D13. With this configuration, the stirrer D16 scatters the electromagnetic wave. This can heat the mixture more uniformly.

### (Thermometer)

The thermometer D17 is a radiation thermometer that detects an infrared ray from the mixture to measure the temperature of the container D14. The thermometer D17 is fixed as a part of a side wall of the electromagnetic wave applying section D13 so that a light receiving section of the thermometer D17 can detect an infrared ray from the powdery mixture MP. The thermometer D17 outputs, to the control section, a temperature signal indicative of the measured temperature of the mixture.

### (Control Section)

The control section may control an output from the electromagnetic wave generator D11 so that the output becomes a given value or so that the temperature indicated by the temperature signal received from the thermometer D17 becomes a predetermined temperature. The predetermined temperature may be constant or may be changed over time. In the present embodiment, the control section controls an output from the electromagnetic wave generator D11 so as to change the value of the output over time. One example of the output control pattern may be a pattern in which an output of 300 W is maintained for 600 seconds and the output is then made to 0 W.

The production method M10 is taken as an example. Then, by accommodating the mixture in the internal space of the container D14 of the dielectric heating device D10 configured as above, it is possible to carry out the heating step S102. Moreover, it is possible to carry out the dissolving step S103 by pouring a sulfuric acidic solution into the container D14 after the heating step S102 is carried out. In a case where the dielectric heating device D10 is used to carry out the dissolving step S103, it is possible to heat the sulfuric acidic solution. Therefore, it is possible to promote the dissolution of the heated mixture in the sulfuric acidic solution. The sulfuric acidic solution of the inorganic substance is an example of the inorganic substance solution.

### Embodiment 7

### (System for Producing Inorganic Substance Solution)

The following description will discuss a device 10 for producing an inorganic substance in accordance with Embodiment 7 of the present invention, with reference to FIG. 8. FIG. 8 is a view schematically illustrating a device 10A that produces an inorganic substance solution and constitutes a part of the device 10 for producing an inorganic substance. Hereinafter, the device 10 for producing an inorganic substance is also simply referred to as a production device 10, and the device 10A for producing an inorganic substance solution is also simply referred to as a production device 10A.

As shown in FIG. 8, the production device 10 includes the production device 10A, and carries out the production method M10 shown in FIG. 1. More specifically, the production device 10A is a device for carrying out the steps of the production method M10 shown in FIG. 1. Note, however, that the production device 10 may include a device for isolating an inorganic substance from an inorganic substance solution obtained by the production device 10A. Examples of such a device include a crystallizer for crystallizing an inorganic substance, an anhydrization device for anhydrizing an inorganic substance solution, and the like.

In the present embodiment, as with in Embodiment 1, an inorganic substance containing natural spodumene is used as the starting material. The natural spodumene contains α-spodumene that is phase-changed to β-spodumene by heating. Note, however, that the starting material in the production device 10A only needs to be an inorganic substance that is phase-changed or thermally decomposed by heating, and is not limited to natural spodumene, as exemplified in Embodiment 1. Examples of an inorganic substance which is thermally decomposed by heating include petalite. In the present embodiment, sodium hydroxide is used as hydroxide, as with in Embodiment 1. The additive in the production device 10A is not limited to sodium hydroxide, as exemplified in Embodiment 1. The additive only needs to be at least one of a hydroxide of alkali metal, a hydroxide of alkaline earth metal, and an oxide of alkaline earth metal. Preferable examples of the additive include, in addition to sodium hydroxide, calcium hydroxide and calcium oxide.

### (Device 10A for Producing Inorganic Substance Solution)

As shown in FIG. 8, the production device 10A includes a grinder 11a, a feeder F1a, a grinder 11b, a feeder F1b, valves V1 and V2, a dielectric heating device 12, and a heat exchanger 13. The production device 10A further includes a control section, which is not shown in FIG. 8. The control section controls the feeders Fla and Fib, the valves V1 and V2, the dielectric heating device 12, and the heat exchanger 13.

The grinder 11a grinds, into powder, natural spodumene, which is the starting material charged thereto. Then, the grinder 11a supplies the powder of natural spodumene to the feeder F1a. The grinder 11a can be selected as appropriate from existing grinders according to desired specifications. Thus, a detailed description of the grinder 11a is omitted here. By grinding the starting material using the grinder 11a, the starting material is mechanically broken to have a smaller particle diameter, and thus efficiency of a chemical reaction with hydroxide or oxide can be improved.

The feeder F1a, which is controlled by the control section, supplies, to the container 12c of the dielectric heating device 12 (described later), the starting material supplied from the grinder 11a.

The grinder 11b grinds, into powder, sodium hydroxide charged thereto. Then, the grinder 11b supplies the powder of sodium hydroxide to the feeder F1b. The grinder 11b can be selected as appropriate from existing grinders according to desired specifications. Thus, a detailed description of the grinder 11b is omitted here. By grinding the sodium hydroxide using the grinder 11b, it is possible to reduce the particle diameter of the sodium hydroxide to a desired size. As described above, the form of the sodium hydroxide is not limited to powder. Therefore, in the production device 10A, the grinder 11b can be omitted.

The feeder F1b, which is controlled by the control section, supplies, to the container 12c of the dielectric heating device 12 (described later), the powder of sodium hydroxide supplied from the grinder 11b. Here, the feeder F1a and the feeder F1b each supply the inorganic substance and the additive to the container 12c so that the proportion of the additive to the inorganic substance is 0.5 or more.

The dielectric heating device 12 includes an electromagnetic wave generator 12a, a waveguide 12b, the container 12c, a stirring mechanism, and a thermometer. The dielectric heating device 12 is one example of the heating section that heats a mixture of an inorganic substance and an additive at a temperature, at which phase change occurs in the inorganic substance, to obtain a mixture (second mixture) of the inorganic substance and the additive. The dielectric heating device 12 carries out the heating step S102 and the dissolving step S103 of the production method M10 shown in FIG. 1.

The electromagnetic wave generator 12a is controlled by the control section, and is configured to oscillate an electromagnetic wave having a given frequency. The given frequency can be selected as appropriate within, for example, the band of a microwave. In the present embodiment, the given frequency is 2.45 GHz. The frequency of 2.45 GHz is identical to that of an electromagnetic wave used in microwave ovens for home use.

The waveguide 12b is a metal tubular member having a first end connected with the electromagnetic wave generator 12a and a second end connected with the container 12c. The waveguide 12b guides, from the first end to the second end, an electromagnetic wave oscillated by the electromagnetic wave generator 12a. Then, the waveguide 12b discharges the electromagnetic wave into an internal space of the container 12c through the second end. Although not shown in FIG. 8, an isolator shown in FIG. 7 is provided midway along the waveguide 12b. In this case, the waveguide D12 shown in FIG. 7 may be read as the waveguide 12b.

In the present embodiment, the dielectric heating device 12 using dielectric heating is used as an example of the heating section. However, the heating section may be an oven, a heater, or the like that uses external heating.

The container 12c is a box-shaped member that accommodates, in its internal space, the powder of the starting material and the powder of the sodium hydroxide. Similarly to the container D14 shown in FIG. 6, the container 12c is made of a material having acid resistance. To the container 12c, powder of the starting material supplied from the grinder 11a via the feeder F1a and powder of sodium hydroxide supplied from the grinder 11b via the feeder F1b are supplied. Inside the container 12c, a stirring mechanism (not shown in FIG. 8) is provided. When the control section causes the stirring mechanism to rotate, the powder of the starting material and the powder of the sodium hydroxide supplied to the internal space of the container 12c are mixed together. As such, the container 12c is one example of the mixing section that mixes the powder of the starting material with the powder of sodium hydroxide to obtain a mixture (first mixture). The container 12c may be a tubular container (e.g., a rotary kiln) that is rotatable about an axis. By combining a liquid supplying section (described later) with the rotary kiln, it is possible to carry out a continuous treatment.

The thermometer (not shown in FIG. 8) detects the temperature of a matter accommodated in the internal space of the container 12c, and outputs a temperature signal indicative of the temperature to the control section. The thermometer may be a noncontact-type thermometer such as a radiation thermometer or a contact-type thermometer such as a thermocouple. Either in a case of employing the noncontact-type thermometer or a case of employing the contact-type thermometer, the thermometer is preferably provided in the internal space of the container 12c and is preferably configured to be capable of directly detecting the temperature of the matter accommodated in the internal space.

The control section may control an output from the electromagnetic wave generator 12a so that the output becomes a given value or so that the temperature indicated by the temperature signal received from the thermometer becomes a predetermined temperature. The predetermined temperature may be constant or may be changed over time. In the present embodiment, the control section controls an output from the electromagnetic wave generator 12a so as to change the temperature indicated by the temperature signal over time according to a given profile. One example of the given profile of the temperature may be a pattern according to which the temperature is instantly changed to 700° C. and then 700° C. is maintained for 30 minutes.

In a case where the heating step S102 of the production method M10 shown in FIG. 1 is carried out with the dielectric heating device 12 configured as described above, a mixture (second mixture) containing the starting material whose phase has been changed and the sodium hydroxide is obtained.

Then, an H₂SO₄ solution is supplied via the valve V1. By supplying the H₂SO₄ solution to the container 12c via the valve V1, the dissolving step S103 is carried out. The mechanism that supplies the H₂SO₄ solution to the container 12c via the valve V1 functions as the liquid supplying section that supplies an acidic solution to the heated mixture. In the container 12c, the mixture is dissolved in the H₂SO₄ solution, and an H₂SO₄ solution containing the inorganic substance is obtained. As described above, the liquid for dissolving the mixture containing the starting material and the sodium hydroxide is not limited to an acid solution such as an H₂SO₄ solution, and may alternatively be water. In a case where water is used as the liquid, the dissolving step S103 is carried out by supplying the water to the container 12c via the valve V1. Thus, the container 12c is an example of the dissolving section that dissolves the mixture of the inorganic substance and the additive in an acid solution or water to obtain a solution of the inorganic substance.

While the dissolving step S103 is being carried out, the control section may control an output from the electromagnetic wave generator 12a so that the output becomes a given value or so that the temperature indicated by the temperature signal received from the thermometer becomes a predetermined temperature. By carrying out the dielectric heating also during the dissolving step S103, dissolution in the H₂SO₄ solution is promoted. While the dissolving step S103 is being carried out, the control section may cause the stirring mechanism to continue to operate.

The valve V2 opens and closes a passage between the internal space of the container 12c and a collection line (not illustrated). The control section closes the valve V2 while the heating step S102 and the dissolving step S103 are being carried out, and opens the valve V2 after the heating step S102 and the dissolving step S103 end. As a result, the inorganic substance solution containing the inorganic substance obtained in the heating step S102 and the dissolving step S103 is collected, in the collection line (not illustrated), from the container 12c.

As described above, the production device 10A can carry out the grinding and mixing step S101, the heating step S102, and the dissolving step S103 of the production method M10 shown in FIG. 1.

### (Variation 1 of Device 10 for Producing Inorganic Substance Solution)

As described above, in the present embodiment, the production device 10 that carries out the steps of the production method M10 shown in FIG. 1 has been described. In this variation, the production device 10 that carries out the production method M20 shown in FIG. 2 will be briefly described. In this variation, the production device 10A carries out the steps of the production method M20 shown in FIG. 2.

The grinder 11a grinds, into powder, natural spodumene, which is the starting material charged thereto (grinding step S201). Then, the grinder 11a supplies the powder of natural spodumene to the feeder F1a. The feeder F1a supplies, to the container 12c of the dielectric heating device 12 (described later), the starting material supplied from the grinder 11a.

The dielectric heating device 12 carries out the phase changing step S202 of the production method M20 shown in FIG. 2.

The grinder 11b grinds, into powder, sodium hydroxide charged thereto. Then, the grinder 11b supplies the powder of sodium hydroxide to the feeder F1b. The feeder F1b supplies, to the container 12c of the dielectric heating device 12 which has carried out the phase changing step S202, the powder of sodium hydroxide supplied from the grinder 11b.

Inside the container 12c, a stirring mechanism (not shown in FIG. 8) is provided. When the control section causes the stirring mechanism to rotate, the heated inorganic substance and the powder of the sodium hydroxide are mixed together in the internal space of the container 12c (mixing step S203).

The dielectric heating device 12 carries out the heating step S204 of the production method M20 shown in FIG. 2.

Then, an H₂SO₄ solution is supplied via the valve V1. By supplying the H₂SO₄ solution to the container 12c via the valve V1, the dissolving step S205 is carried out. By opening the valve V2 after the dissolving step S205 is carried out, the inorganic substance solution obtained in the dissolving step S205 is collected, in the collection line (not illustrated), from the container 12c.

As described above, in the variation of the production device 10, it is possible to carry out the grinding step S201, the phase changing step S202, the mixing step S203, the heating step S204, and the dissolving step S205 of the production method M20 shown in FIG. 2.

### (Variation 2 of Device 10 for Producing Inorganic Substance Solution)

As described above, in the production device 10, natural spodumene (i.e., α-spodumene) is used as an inorganic substance. However, it may be possible that β-spodumene is obtained instead of α-spodumene for some reason. In such a case also, an aspect of the present invention can be suitably utilized.

That is, an aspect of the present invention may include: a mixing section for mixing an inorganic substance containing β-spodumene and the foregoing additive to obtain a mixture (first mixing section); and a heating section for heating the mixture to obtain a mixture (second mixing section) of the inorganic substance and the additive. In this variation also, a proportion of the additive to the inorganic substance in the mixing section is 0.5 or more in terms of molar ratio.

### EXAMPLE GROUP

The following description will discuss an Example group of the present invention. In the following Example group, natural spodumene (α-spodumene) was used as the starting material.

### Example 1

In Example 1, in the production method M10 shown in FIG. 1, the grinding and mixing step S101 through the dissolving step S103 were carried out. In this Example, sodium hydroxide was used as at least one of hydroxide and oxide to be mixed in the grinding and mixing step S101. In this Example, in the dissolving step S103, sulfuric acid was used as the acid solution.

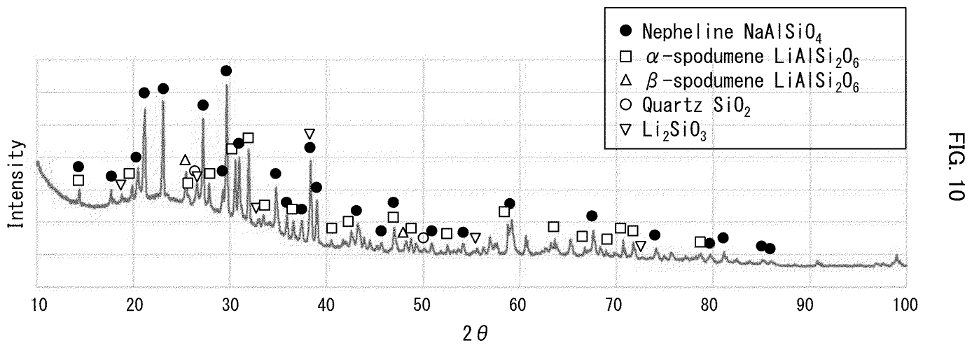

In this Example, in the grinding and mixing step S101, 1 g of natural spodumene was ground to be smaller than 600 μm. In the grinding and mixing step S101, the natural spodumene and the sodium hydroxide were mixed at a molar ratio of 1:1. In the heating step S102, dielectric heating at 500° C. was carried out for 15 minutes to 30 minutes with the dielectric heating device D10 in the air atmosphere under normal pressure. In a test section 1, a mixture of the spodumene and the sodium hydroxide was placed on a flat alumina dish, and dielectrically heated. In a test section 2, the mixture was placed on an alumina crucible dish and dielectrically heated. By carrying out the heating step S102, the mixture of the spodumene and the sodium hydroxide was solidified according to dielectric heating. In the test section 1, the unreacted part remained as powder. In the test section 2, the entire mixture was solidified after heating. The mixture after heating is shown in FIG. 9.

Then, in the dissolving step S103, the mixture obtained after heating was dissolved in the concentrated sulfuric acid at room temperature under normal pressure, and thus an inorganic substance solution was obtained.

An elution rate of Li contained in the inorganic substance solution was calculated. The elution rate was calculated according to formula (1) below after quantitative measurement using ICP was carried out with respect to the inorganic substance solution. The percent by Li element weight of the starting material was calculated by quantitative analysis. The results are indicated in Table 1.

$$Elution rate ( \% ) = ( Li content in solution ) / ( Li content in raw material ) \times 100 \qquad ( 2 )$$

TABLE 1

| Condition | Li elution rate |
|---|---|
| Test section 1 | 64% |
| Test section 2 | 82% |

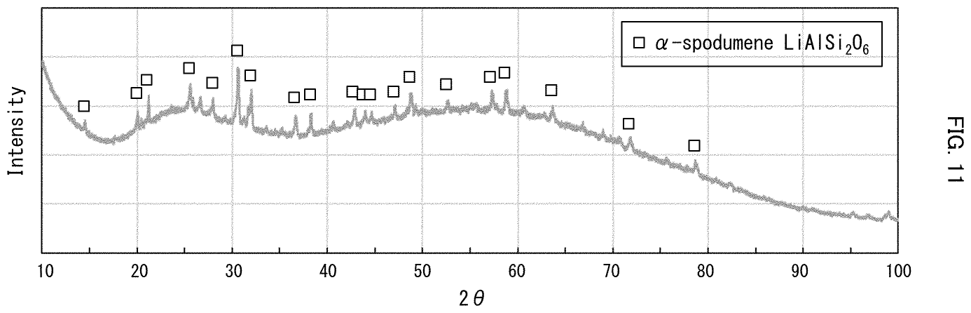

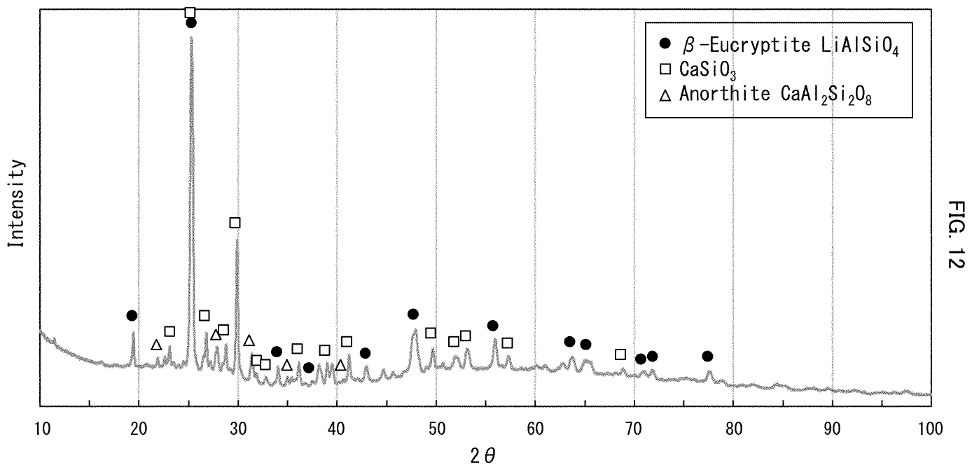

In the test section 1, an X-ray analysis (XRD) test was carried out on the solidified part of the mixture obtained after heating and on the solid phase (residue) in the inorganic substance solution obtained by dissolving the solidified part. The results are indicated in FIG. 10 and FIG. 11, respectively.

As shown in FIG. 9, the solidified part was greater in the test section 2 than in the test section 1. As shown in Table 1, the elution rate of Li was higher in the test section 2 than in the test section 1. As such, it was indicated that, by using the dish with a round bottom rather than the flat dish during dielectric heating, the efficiency of dielectric heating was enhanced and the elution rate was heightened.

As shown in FIG. 10, by the heating step S102, the mixture was found to contain Li₂SiO₃, nepheline (NaAlSiO₄), α-spodumene (LiAlSi₂O₆), β-spodumene (LiAlSi₂O₆), and quartz (SiO₂). As shown in FIG. 11, by the dissolving step S103, among the compounds shown in FIG. 10, compounds other than α-spodumene (LiAlSi₂O₆) were eluted in the inorganic substance solution. Thus, it was shown that, according to the method for producing an inorganic substance solution in accordance with an aspect of the present invention, β-spodumene, Li₂SiO₃, nepheline, and quartz can be generated from natural spodumene (α-spodumene), which is the starting material, by the heating step, and Li can be eluted in the inorganic substance solution.

### Example 2

In Example 2, in the production method M10 shown in FIG. 1, the grinding and mixing step S101 through the dissolving step S103 were carried out. In this Example, as at least one of hydroxide and oxide to be mixed in the grinding and mixing step S101, calcium hydroxide was used in a test section 3, calcium oxide was used in a test section 4, and calcium carbonate was used in Reference Example 1. In this Example, in the dissolving step S103, concentrated sulfuric acid was used as the acid solution.

In this Example, in the grinding and mixing step S101, 1 g of natural spodumene was ground to be smaller than 600 μm. In the grinding and mixing step S101, the natural spodumene and the at least one of hydroxide and oxide were mixed at a molar ratio of 1:1. In the heating step S102, external heating at 1050° C. was carried out for 30 minutes in the air atmosphere under normal pressure.

Then, in the dissolving step S103, the mixture obtained after heating was dissolved in the concentrated sulfuric acid at room temperature under normal pressure, and thus an inorganic substance solution was obtained.

An elution rate of Li contained in the inorganic substance solution was calculated with a method similar to that in Example 1. The results are indicated in Table 2.

TABLE 2

| Condition | Li elution rate |
|---|---|
| Test section 3 | 64% |
| Test section 4 | 94% |
| Reference Example 1 | 14% |

In the test section 4, an XRD test was carried out on the mixture obtained after heating. The result is indicated in FIG. 12.

As shown in Table 2, in the test sections 3 and 4, the elution rate of Li was 50% or more. It was found that, by mixing the inorganic substance and at least one of hydroxide and oxide, Li can be eluted efficiently.

As shown in FIG. 12, by the heating step S102, the mixture was found to contain β-eucryptite (LiAlSiO₄), CaSiO₃, and anorthite (CaAl₂Si₂O₈). Thus, it was shown that, according to the method for producing an inorganic substance solution in accordance with an aspect of the present invention, β-eucryptite, CaSiO₃, and anorthite can be generated from natural spodumene (α-spodumene), which is the starting material, by the heating step, and Li can be eluted in the inorganic substance solution.

### Example 3

In Example 3, in the production method M10 shown in FIG. 1, the grinding and mixing step S101 through the dissolving step S103 were carried out. In this Example, calcium oxide was used as at least one of hydroxide and oxide to be mixed in the grinding and mixing step S101. In this Example, in the dissolving step S103, concentrated sulfuric acid was used as the acid solution.

In this Example, in the grinding and mixing step S101, 1 g of natural spodumene was ground to be smaller than 600 μm. In the grinding and mixing step S101, the natural spodumene and at least one of hydroxide and oxide were mixed together at molar ratios of 1:1 in a test section 5, 1:0.66 in a test section 6, and 1:0.33 in Reference Example 2. In the heating step S102, external heating at 1050° C. was carried out for 30 minutes in the air atmosphere under normal pressure.

Then, in the dissolving step S103, the mixture obtained after heating was dissolved in the concentrated sulfuric acid at room temperature under normal pressure, and thus an inorganic substance solution was obtained.

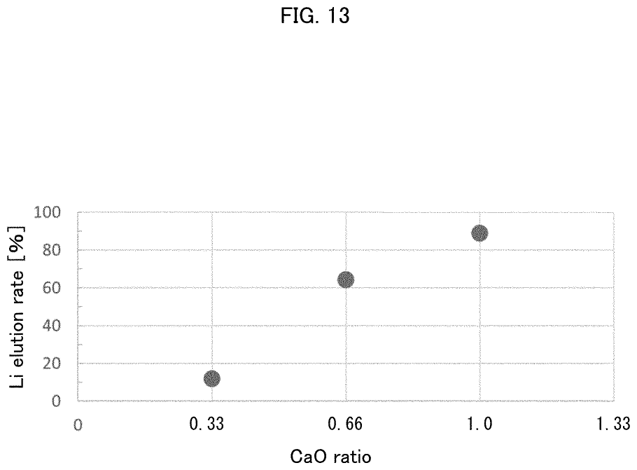

An elution rate of Li contained in the inorganic substance solution was calculated with a method similar to that in Example 1. The results are indicated in Table 3. FIG. 13 shows a relationship between the Li elution rate and the molar ratio of natural spodumene and calcium carbonate.

TABLE 3

| Condition | Li elution rate |
|---|---|
| Test section 5 | 89% |
| Test section 6 | 64% |
| Reference Example 2 | 12% |

As shown in Table 3 and FIG. 13, in the test sections 5 and 6, the elution rate of Li was 50% or more. Therefore, in a case where natural spodumene was used as the starting material, it was clear that an inorganic substance solution in which the elution rate of Li was 50% or more could be obtained by using calcium carbonate having a weight ratio of 0.2 or more relative to the natural spodumene.

### ADDITIONAL REMARKS

The present invention is not limited to the embodiments, but can be altered by a skilled person in the art within the scope of the claims. The present invention also encompasses, in its technical scope, any embodiment derived by combining technical means disclosed in differing embodiments.

Aspects of the present invention can also be expressed as follows:

In order to attain the object, a method for producing an inorganic substance solution in accordance with aspect 1 of the present invention includes: a mixing step of mixing an inorganic substance and an additive to obtain a first mixture, the inorganic substance being phase-changed or thermally decomposed by heating, and the additive being at least one of a hydroxide of alkali metal, a hydroxide of alkaline earth metal, and an oxide of alkaline earth metal; and a heating step of heating the first mixture at a heating temperature not lower than a predetermined temperature to obtain a second mixture of the inorganic substance and the additive. In this production method, a configuration is employed in which a proportion of the additive to the inorganic substance in the mixing step is 0.5 or more in terms of molar ratio, and the predetermined temperature is (1) a temperature at which phase change occurs in a case where the inorganic substance is an inorganic substance whose phase is to be changed by heating and (2) a temperature at which thermal decomposition occurs in a case where the inorganic substance is an inorganic substance which is to be thermally decomposed by heating.

The second mixture obtained by this production method can be dissolved in a solvent without high temperature or high temperature and high pressure, unlike the conventional techniques disclosed in Non-Patent Literature 1 and Patent Literature 1. Therefore, according to the above configuration, it is possible to provide a technique that makes it possible to dissolve an inorganic substance such as lithium ore more easily than the conventional techniques disclosed in Non-Patent Literature 1 and Patent Literature 1.

Hereinafter, a proportion of the additive to the inorganic substance is expressed using the molar ratio, unless otherwise specified.

The method in accordance with aspect 2 of the present invention employs, in addition to the feature of aspect 3 above, a feature in which: the inorganic substance contains α-spodumene that is phase-changed to β-spodumene by heating.

The inventors of the present invention have found that, in a case where lithium ore is used as an inorganic substance, it is possible, by phase-changing α-spodumene to β-spodumene, to reduce the amount of an additive to be mixed.

The method in accordance with aspect 3 of the present invention employs, in addition to the feature of aspect 2 above, a feature in which: the additive is at least one of sodium hydroxide, calcium hydroxide, and calcium oxide.

The inventors of the present invention have found that it is preferable to use at least one of sodium hydroxide, calcium hydroxide, and calcium oxide as an additive used in this production method.

The method in accordance with aspect 4 of the present invention employs, in addition to the feature of aspect 1 above, a feature in which: the inorganic substance contains petalite that is thermally decomposed by heating.

In a case where petalite is used as an inorganic substance, it is possible, by thermally decomposing the petalite, to reduce the amount of the additive to be mixed.

The method in accordance with aspect 5 of the present invention employs, in addition to the feature of any one of aspects 1 to 4 above, a feature in which: in the heating step, the first mixture is heated using dielectric heating.

According to the above configuration, it is possible to heat the first mixture efficiently. Therefore, it is possible to reduce the cost of producing the inorganic substance solution. Moreover, it is possible to contribute to the SDGs.

The method in accordance with aspect 6 of the present invention employs, in addition to the feature of any one of aspects 1 to 5 above, a feature of further including: a dissolving step of dissolving the second mixture, which has been obtained in the heating step, in an acid solution or water to obtain a solution of the inorganic substance.

The second mixture obtained by this production method allows the inorganic substance to be dissolved in a solvent without high temperature or high temperature and high pressure, unlike the conventional techniques disclosed in Non-Patent Literature 1 and Patent Literature 1. Therefore, according to the above configuration, it is possible to obtain a solution of an inorganic substance such as lithium ore more easily than the conventional techniques disclosed in Non-Patent Literature 1 and Patent Literature 1.

In order to attain the object, a method for producing an inorganic substance solution in accordance with aspect 7 of the present invention includes: a phase changing step of changing, by heating, a phase of an inorganic substance that is to be phase-changed by heating; a mixing step of mixing the inorganic substance which has been phase-changed and an additive to obtain a first mixture, the additive being at least one of a hydroxide of alkali metal, a hydroxide of alkaline earth metal, and an oxide of alkaline earth metal; and a heating step of heating the first mixture to obtain a second mixture of the inorganic substance and the additive. In this inorganic substance solution production method, a configuration is employed in which a proportion of the additive to the inorganic substance in the mixing step is 0.5 or more in terms of molar ratio.

In the inorganic substance solution production method in accordance with aspect 7 of the present invention, heat energy for phase-changing the inorganic substance and heat energy for causing the inorganic substance after phase change to react with a compound that easily dissolves the inorganic substance are applied to the inorganic substance using the same step (heating step). Note, however, that, in a method for producing an inorganic substance solution in accordance with an aspect of the present invention, it is possible to apply the above-described two heat energies to the inorganic substance using separate steps (phase changing step and heating step), as in this production method.

In order to attain the object, a method for producing an inorganic substance solution in accordance with aspect 8 of the present invention includes: a mixing step of mixing an inorganic substance and an additive to obtain a first mixture, the inorganic substance containing β-spodumene, and the additive being at least one of a hydroxide of alkali metal, a hydroxide of alkaline earth metal, and an oxide of alkaline earth metal; and a heating step of heating the first mixture to obtain a second mixture of the inorganic substance and the additive. In this production method, a configuration is employed in which a proportion of the additive to the inorganic substance in the mixing step is 0.5 or more in terms of molar ratio.

One aspect of the present invention can also be suitably used in a case where a starting material containing β-spodumene is used as an inorganic substance.

In order to attain the object, a device for producing an inorganic substance solution in accordance with aspect 9 of the present invention includes: a mixing section for mixing an inorganic substance and an additive to obtain a first mixture, the inorganic substance being phase-changed or thermally decomposed by heating, and the additive being at least one of a hydroxide of alkali metal, a hydroxide of alkaline earth metal, and an oxide of alkaline earth metal; and a heating section for heating the first mixture at a heating temperature not lower than a predetermined temperature to obtain a second mixture of the inorganic substance and the additive. In this production device, a configuration is employed in which a proportion of the additive to the inorganic substance in the mixing section is 0.5 or more in terms of molar ratio, and the predetermined temperature is (1) a temperature at which phase change occurs in a case where the inorganic substance is an inorganic substance whose phase is to be changed by heating and (2) a temperature at which thermal decomposition occurs in a case where the inorganic substance is an inorganic substance which is to be thermally decomposed by heating.

The device in accordance with aspect 10 of the present invention employs, in addition to the feature of aspect 9 above, a feature in which: the inorganic substance contains α-spodumene that is phase-changed to β-spodumene by heating.

The device in accordance with aspect 11 of the present invention employs, in addition to the feature of aspect 10 above, a feature in which: the additive is at least one of sodium hydroxide, calcium hydroxide, and calcium oxide.

The device in accordance with aspect 12 of the present invention employs, in addition to the feature of aspect 9 above, a feature in which: the inorganic substance contains petalite that is thermally decomposed by heating.

The device in accordance with aspect 13 of the present invention employs, in addition to the feature of any one of aspects 9 to 12 above, a feature in which: the heating section heats the first mixture using dielectric heating.

The device in accordance with aspect 14 of the present invention employs, in addition to the feature of any one of aspects 9 to 12 above, a feature of further including: a dissolving section for dissolving the second mixture, which has been obtained by the heating section, in an acid solution or water to obtain a solution of the inorganic substance.

The devices for producing an inorganic substance solution in accordance with aspects 9 to 14 of the present invention correspond to the methods for producing an inorganic substance solution in accordance with aspects 1 to 6 of the present invention, respectively. Therefore, the devices for producing an inorganic substance solution in accordance with aspects 9 to 14 of the present invention bring about the same effects as the respective methods for producing an inorganic substance solution in accordance with aspects 1 to 6 of the present invention.

### REFERENCE SIGNS LIST

M10: Production method (method for producing inorganic substance solution)
S102: Heating step
S103: Dissolving step
D10, 22: Dielectric heating device (device for producing inorganic substance solution)
D11, 12a: Electromagnetic wave generator
D12, 12b: Waveguide
D14, 12c: Container
D18: Isolator

1. A method for producing an inorganic substance solution, said method comprising:
a mixing step of mixing an inorganic substance and an additive to obtain a first mixture, the inorganic substance being phase-changed or thermally decomposed by heating, and the additive being at least one of a hydroxide of alkali metal, a hydroxide of alkaline earth metal, and an oxide of alkaline earth metal; and
a heating step of heating the first mixture at a heating temperature not lower than a predetermined temperature to obtain a second mixture of the inorganic substance and the additive,
a proportion of the additive to the inorganic substance in the mixing step being 0.5 or more in terms of molar ratio, and
the predetermined temperature being (1) a temperature at which phase change occurs in a case where the inorganic substance is an inorganic substance whose phase is to be changed by heating and (2) a temperature at which thermal decomposition occurs in a case where the inorganic substance is an inorganic substance which is to be thermally decomposed by heating.

2. The method as set forth in claim 1, wherein:
the inorganic substance contains α-spodumene that is phase-changed to β-spodumene by heating.

3. The method as set forth in claim 2, wherein:
the additive is at least one of sodium hydroxide, calcium hydroxide, and calcium oxide.

4. The method as set forth in claim 1, wherein:
the inorganic substance contains petalite that is thermally decomposed by heating.

5. The method as set forth in claim 1, wherein:
in the heating step, the first mixture is heated using dielectric heating.

6. The method as set forth in claim 1, further comprising:
a dissolving step of dissolving the second mixture, which has been obtained in the heating step, in an acid solution or water to obtain a solution of the inorganic substance.

7. A method for producing an inorganic substance solution, said method comprising:
a phase changing step of changing, by heating, a phase of an inorganic substance that is to be phase-changed by heating;
a mixing step of mixing the inorganic substance which has been phase-changed and an additive to obtain a first mixture, the additive being at least one of a hydroxide of alkali metal, a hydroxide of alkaline earth metal, and an oxide of alkaline earth metal; and
a heating step of heating the first mixture to obtain a second mixture of the inorganic substance and the additive,
a proportion of the additive to the inorganic substance in the mixing step being 0.5 or more in terms of molar ratio.

8. (canceled)

9. A device for producing an inorganic substance solution, said device comprising:
a mixing section for mixing an inorganic substance and an additive to obtain a first mixture, the inorganic substance being phase-changed or thermally decomposed by heating, and the additive being at least one of a hydroxide of alkali metal, a hydroxide of alkaline earth metal, and an oxide of alkaline earth metal; and
a heating section for heating the first mixture at a heating temperature not lower than a predetermined temperature to obtain a second mixture of the inorganic substance and the additive,
a proportion of the additive to the inorganic substance in the mixing section being 0.5 or more in terms of molar ratio, and
the predetermined temperature being (1) a temperature at which phase change occurs in a case where the inorganic substance is an inorganic substance whose phase is to be changed by heating and (2) a temperature at which thermal decomposition occurs in a case where the inorganic substance is an inorganic substance which is to be thermally decomposed by heating.

10. The device as set forth in claim 9, wherein:
the inorganic substance contains α-spodumene that is phase-changed to β-spodumene by heating.

11. The device as set forth in claim 10, wherein:
the additive is at least one of sodium hydroxide, calcium hydroxide, and calcium oxide.

12. The device as set forth in claim 9, wherein:
the inorganic substance contains petalite that is thermally decomposed by heating.

13. The device as set forth in claim 9, wherein:
the heating section heats the first mixture using dielectric heating.

14. The device as set forth in claim 9, further comprising:
a dissolving section for dissolving the second mixture, which has been obtained by the heating section, in an acid solution or water to obtain a solution of the inorganic substance.
